(19) United States
(12) Patent Application Publication
(10) Pub. No.: US 2018/0122251 A1
(43) Pub. Date: May 3, 2018

(54) SYSTEMS, METHODS AND TECHNIQUES FOR E-EDUCATION ON AN INTERACTIVE INFORMATION PLATFORM

(71) Applicant: Beijing Century Superstar Information Technology Co., Ltd., Beijing (CN)

(72) Inventor: CHAO SHI, Beijing (CN)

(21) Appl. No.: 15/442,725

(22) Filed: Feb. 27, 2017

(30) Foreign Application Priority Data
Nov. 2, 2016 (CN) 201610946055.0
Nov. 2, 2016 (CN) 201621170016.8

(51) Int. Cl. G09B 5/06; G09B 5/02; G09B 5/00; G09B 5/04

(52) U.S. Cl. CPC G09B 5/06; G09B 5/04; G09B 5/00; G09B 5/02

(57) ABSTRACT

Systems, methods and techniques for providing courses on an interactive information platform are described herein. A user is allowed to develop an electronic syllabus for a course. The electronic syllabus contains at least one executable software component generated based on an executable software components stored on the interactive information platform. An interactive virtual classroom is provided to allow other users on the interactive information platform to participate in the course. An instructor of the course may teach the course in the provided interactive virtual classroom based on the developed electronic syllabus. During the process of teaching the course, the at least one executable software component contained in the electronic syllabus is deployed to the interactive virtual classroom. In addition, a plurality of assessment records of a student participating in the course are generated based on recorded behaviors of the student. A screen displays a plurality of visual objects, each of which corresponds to one of the assessment records of the student.

### CROSS REFERENCE TO RELATED APPLICATION

This application claims priority to the disclosures of Chinese Patent Applications No. 201610946055.0 and 201621170016.8 filed on Nov. 2, 2016, all of which are incorporated herein by reference.

### FIELD OF THE DISCLOSURE

Example embodiments disclosed herein relate generally to e-education, and more particularly to systems, methods and techniques for teaching a course on an interactive information platform based on a defined electronic syllabus containing executable components.

### BACKGROUND AND SUMMARY

E-education, such as MOOC (Massive Open Online Courses), eliminates geographical boundaries for educational delivery. To varying degrees, anyone theoretically may log on from anywhere accessible to Internet or other network to participate in online courses. Students may participate in these courses at any time in order to watch a lecture, complete assignments, or participate in real-time discussions with other students or instructors. On the other hand, instructors may develop and teach courses in specific areas of teaching, give lectures, post assignments, grade completed assignments or interact with students, from anywhere having Internet or other network access.

E-education provides user-friendly educational environments, especially for people pursuing continuing education programs. Students are not limited to physically attending courses or reading printed materials, and are able to learn knowledge or skills in more interactive and dynamic environments. Multimedia materials including images, audios, videos, animations, and/or slide shows may be used as good alternatives to printed materials. However, developing and teaching courses could pose technical challenges on instructors. Certain classroom activities, such as discussions, voting, or competitive answering, could be difficult for instructors to incorporate into their courses taught via an interactive platform. Conventional e-learning authoring tools for developing interactive courses are often more complex than what an instructor is able to use. Therefore, there is a need to provide a course development tool and a learning environment that facilitates instructors to easily develop or teach courses including not only multimedia data but also activities serving for educational purposes.

To solve the above identified technical problems, example embodiments of the present invention provide an interactive information platform including a more user-friendly course development tool, which allows instructors to easily select educational materials from a wider and richer variety of materials. The course development tool is provided as a part of an e-education service provided by the interactive information platform. Diverse educational materials are pre-defined and stored on the interactive information platform. Educational materials include not only text and multimedia data, but also executable software components that can be executed to perform classroom activities like quizzes, voting, and discussions, etc. Educational materials can also be created by people other than the actual instructor, such as third-party teachers, animators, and so on. Users on the platform may share or reuse educational materials among each other. Instructors may easily choose and customize various educational materials on the platform and synthesize these materials into an electronic syllabus for a course, in accordance with their specific needs and desires.

The interactive information platform also allows instructors to teach courses and allows students to participate in courses. In teaching a course, instructors may provide to students traditional lectures in the form of recorded video or audio information, or traditional reading assignments posted online. In addition, they may also perform various types of classroom activities, such as voting, quizzes, alerts, or calling the roll, through running executable software components defined for a course. An instructor can easily pull educational materials from a developed electronic syllabus into the corresponding course to make them accessible to students. Moreover, instructors may also participate in real-time discussions with students on an example interactive information platform. Every student has his or her own learning requirements, and the platform provides various kinds of resources, learning styles, communication tools and flexibility to accommodate this diversity.

Further, an example interactive information platform may monitor and record the behaviors of a user, such as posting messages or articles, completing assignments or tests, reading articles, or participating in a class, etc. Assessment records may be generated for each user on the platform based on the recorded user behaviors. As a result, the platform may display a set of visual objects corresponding to the assessment records of a user, and the visual objects may vary (e.g., in size or color) in terms of the values of the assessment records.

The technology described in this disclosure is directed to a method for providing courses on an interactive information platform. The method comprises enabling a user to develop an electronic syllabus for a course, which contains at least one executable software component generated based on an executable software component stored on the interactive information platform. In certain example embodiments, the electronic syllabus could also contain text, images, videos, audios, and various other kinds of content. Software components stored on the interactive information platform include an application that is executable to perform various classroom activities, such as a voting, a quiz, a roll call, or a discussion.

The method further comprises providing an interactive virtual classroom to allow other users on the platform to participate in a course, and enabling the user to teach the course in the provided virtual classroom based on the developed electronic syllabus. During the process of teaching the course, the executable software component contained in the electronic syllabus can be deployed to the virtual classroom to, for example, conduct a voting, a quiz, a roll call or a discussion in the virtual classroom.

In certain example embodiments, in the process of developing an electronic syllabus for a course, an instructor may select one of the software components stored on an interactive information platform as a component of the electronic syllabus. The software components may be created by the platform or users. Moreover, the instructor may customize the selected software component in accordance with his specific desires or needs. In other example embodiments, some executable software components from an interactive information platform may be automatically selected and customized for a specific course. For example, the platform may automatically add software components for calling a roll and conducting a discussion into an electronic syllabus as default components.

In an example embodiment, the method further comprises enabling the user and/or any of the other users participating in the course to interactive with at least one executable software component deployed in its corresponding interactive virtual classroom.

In another example embodiment, the method further comprises enabling the user and/or any of the other users participating in the course to post a message on the interactive virtual classroom.

In yet another example embodiment, the method further comprises recording behaviors of users of the interactive information platform. After that, a plurality of assessment records of a user participating in the course may be generated based on the recorded behaviors of the user. Each of the generated assessment records of the user may be displayed on a screen as a visual object, which varies in response to its corresponding assessment record. For example, a visual object varies in size or shape according to the value of its corresponding assessment record.

The technology described in this disclosure is also directed to a non-transitory computer readable storage medium storing a computer program having code executable by an information processing apparatus, the computer program, when executed, causing the information processing apparatus to provide execution comprising enabling a user to develop an electronic syllabus for a course, which contains at least one executable software component generated based on an executable software components stored on an interactive information platform. In an example embodiment, in developing an electronic syllabus for a course, the user may customize an executable software component in accordance with his desires or needs.

The provided execution further comprises providing an interactive virtual classroom to allow other users on the interactive information platform to participate in the course, and enabling the user to teach the course in the interactive virtual classroom based on the developed electronic syllabus. During the process of teaching the course, the at least one executable software component contained in the electronic syllabus is deployed to the interactive virtual classroom. After that, the user and/or any of the other users participating in the course are able to interactive with the at least one executable software component in the interactive virtual classroom.

Furthermore, the technology described in this disclosure is directed to a system for providing courses on an interactive information platform, comprising a processing system having at least one processor, the processing system configured to enable a user on the interactive information platform to generate a course, and enabling a user to develop an electronic syllabus for a course, which contains at least one executable software component generated based on an executable software component stored on the interactive information platform. The executable software component contained in the electronic syllabus may be selected and customized by the user based on his/her desires, or automatically customized by the platform for the corresponding course.

Moreover, the processing system is further configured to provide an interactive virtual classroom to allow other users on the interactive information platform to participate in the course, and enable the user to teach the course in the interactive virtual classroom based on the developed electronic syllabus. During the process of teaching the course, the at least one executable software component contained in the electronic syllabus is deployed to the interactive virtual classroom. After that, the user and any of the other users participating in the course are able to interactive with the at least one executable software component deployed in the interactive virtual classroom.

### BRIEF DESCRIPTION OF THE DRAWINGS

The accompanying drawings facilitate an understanding of the various preferred embodiments of this invention. In such drawings:

FIG. 1 shows a system architecture of a non-limiting example interactive information platform;

FIG. 2 shows a user interface of a non-limiting example interactive information platform;

FIG. 3 shows a workflow of an e-education service provided by a non-limiting example interactive information platform;

FIG. 4 shows a user interface of a non-limiting example course development tool for developing an electronic syllabus;

FIG. 5 shows a user interface of a course provided by a non-limiting example interactive information platform;

FIG. 6 shows a user interface of a non-limiting example interactive virtual classroom provided for a course;

FIG. 7 shows a user interface displaying a set of visual objects corresponding to assessment records of a user on a non-limiting example interactive information platform.

FIG. 8 shows a user interface displaying details of a voting activity conducted in a virtual classroom of a course provided by a non-limiting example interactive information platform, and

FIG. 9 shows a user interface displaying details of the users who have voted for a specific choice in a virtual classroom of a course provided by a non-limiting example interactive information platform.

### DETAILED DESCRIPTION OF EXEMPLARY EMBODIMENTS

In accordance with certain exemplary embodiments, certain systems, device, processes and methods are disclosed for e-education, more particularly, certain exemplary embodiments relate to teaching a course on an interactive information platform in accordance with a pre-defined electronic syllabus are described herein. In the following description, for purpose of explanation, numerous specific details are set forth to provide a thorough understanding of the exemplary embodiments. It will be evident, however, to a person skilled in the art that the exemplary embodiments may be practiced without these specific details.

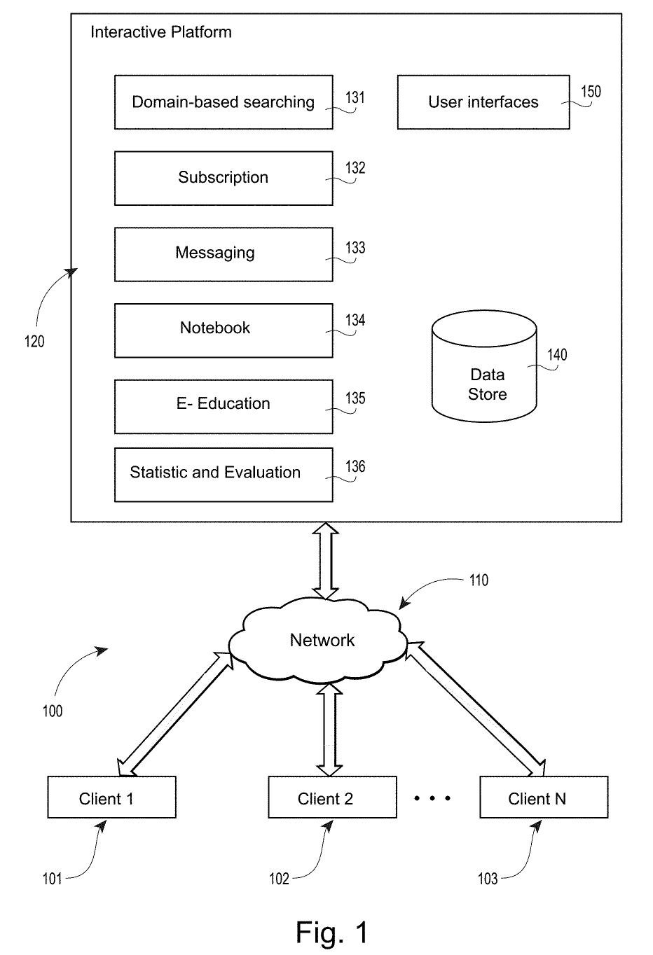

Referring now to FIG. 1, a diagram 100 illustrating the system architecture of an example embodiment of the technology described herein. Some example embodiments may have different and/or other sub-modules than the ones described herein. Similarly, the functions can be distributed among the sub-modules in accordance with other embodiments in a different manner than is described herein.

The system architecture 100 includes a plurality of client electronic devices 101-103, an interactive information platform 120 and a network 110. The client electronic devices 101-103 may be any kinds of computing devices, such as, desktop computers, personal computers (PCs), smart phones, personal digital assistants (PDAs), tablet devices, etc. The client electronic devices 101-103 are communicably coupled to the interactive information platform 120 via the network 110. The network 110 may be a public network (e.g., Internet) or a private network (e.g., Ethernet or a local area Network).

In certain example embodiments, via the client electronic devices 101-103, clients interact with the interactive information platform 120 by exchanging messages or information via standard protocols, e.g., File Transfer Protocol (FTP) and Hypertext Transfer Protocol (HTTP), etc. Each client runs at least one application to generate information or messages to communicate with the interactive information platform 120. In these example embodiments, client electronic devices 101-103 may display graphic user interfaces for users to interact with the platform 120 as well.

The interactive information platform 120 depicted in FIG. 1 provides various services to clients, including, for example, domain-based content searching 131, subscription 132, messaging 133, notebook 134, e-education 135, and statistic and evaluation service 136. The interactive information platform 120 also provides user interfaces 150 for accessing to the services provided by the platform 120. In alternative example embodiments, any one of the services supported by an interactive information platform may be installed locally in a client electronic device.

The e-education service 135 allows instructors to develop courses via the interactive information platform 120, allows students to participate in one or more courses on the interactive information platform 120, and allows instructors to teach courses. Instructors via their client electronic devices may develop a courses and teach the course through interaction between their devices and the platform 120. Students via their client electronic devices are also connected with network 110. Students interact with one or more instructors, and with the platform 120 in order to participate in one or more courses.

The domain-based content searching service 131 allows users to define domains representing digital resources filtered out in accordance with their specific needs, and to extract digital resources from various domains in accordance with particular search term(s).

The subscription service 132 allows users to subscribe to specific digital resources. The digital resources to be subscribed include not only digital resources related to specific topics, in particular fields, and/or of particular types, but also courses provided by the interactive information platform 120.

The notebook service 134 allows users on the interactive information platform 120 to post notes on their personal spaces on the platform 120, share their notes with a predetermined group of users or all of the users on the platform 120, review notes posted by other users, and comment on notes posted by other users.

The messaging service 133 allows a user of the interactive information platform 120 to send messages to other users, such as friends of the user, company contacts of the user, or contacts within the user's mobile phone. A user may also initiate a group chat among a group of users on the platform 120. The social media based information platform encourages collaboration and engagement amongst users.

The statistic and evaluation service 136 generates statistics information based on at least in part upon events detected on the platform. The platform may generate new statistics information whenever one of a predetermined set of events detected. The predetermined events include creating a post, subscribing to an article, adding a friend, creating a course, participating in a course, and so on. Statistics information comprises data that is collected, analyzed or otherwise processed to define one or more quantitative and/or qualitative characteristics about a user, a group of users, an article, a course, or an application, etc. Statistic information may be stored in memory or other storages.

Statistics information reveals characteristics associated with the historical behaviors of a user, e.g., how well a user has finished a quiz, how many articles have been posted by a user, how many books have been subscribed by a user, how many friends a user has, etc. In addition, statistics information also reveals characteristics associated with an article, a course, or an application, or any other kinds of objects on the platform, e.g., how many students have registered for a course, how many users have reviewed an article, how many users have used an application.

The platform may then present statistics information to users to reflect the current characteristics of a user, an article, a book, a course, an application or any other objects on the platform. As detailed below, the statistics information may be presented to users in a textual form, tables, graphics, visual objects, or any other forms.

This interactive information platform 120 involves various technologies, including one-step content retrieval, information collection, digital reading, instant messaging, communication security, message stack pushing, and location based service. Various services, for example the services 131-136, need to work with each other, and be called by each other, and, in the meantime, the platform 120 requires to ensure data security. The platform 120 requires both high stability and scalability, and various modules are organized in a framework with low coupling but high cohesion. Conventional content service providers seldom implement this type of architecture that supports multiple kinds of services, and multiple kinds of terminals (e.g., personal computers, or hand-held terminals, etc.).

In some example embodiments of the present invention, Service Oriented Architecture (SOA) based middleware technology, which is a lightweight Enterprise Service Bus (ESB) architecture, is used to support the provisioning of various services realized from standalone components. The SOA is a technical architecture that defines a way to publish, discover, operate, and manage various services. The architecture combines middleware and web service technologies. It detaches core services from other services and provides interfaces for accessing external services, so that subsystems with required privileges may access to external services via these interfaces. This architecture provides a flexible connectivity framework supporting reliable and secure system integration. A person of ordinary skill in the art would understand that any other architecture may also be utilized to implement the interactive information platform.

In certain example embodiments, services provided by the interactive information platform 120 are not directly interact with each other, but communicate with each other through an ESB, which is an architectural construct used as an intermediary to coordinate the differences due to different systems, communication protocols (e.g., Web Service, HTTP, JSON, etc.), or data formats. There may be different types of applications with each comprising a different port type, for example, an application that uses SOAP over HTTP to communicate with the ESB. ESBs can broker various services in a SOA, so that applications do not need to know the identity, physical location, communication protocols, or port definitions of the service providers.

Although the term “ESB service” is used in the disclosure, a person of ordinary skill in the art will understand that the embodiments described herein can be applied to any service provided to a client that communicates with the service by any kinds of messages.

In addition, as shown in FIG. 1, the platform 120 supports protocol conversion (e.g., Web Service, HTTP, JSON, etc.), message transformation (e.g., the conversion, enrichment, or filtration of a message, etc.), and message routing in various manners (e.g., synchronous/asynchronous, publish/subscribe, content-based routing, or branching and aggregation, etc.). Furthermore, the platform 120 also enables orchestrating multiple services to form a new service.

The interactive information platform 120 includes a data store 140 for storing digital resources and other kinds of data supporting the services provided by the platform. In certain example embodiments, at least a part of the data supporting a provided service may be stored locally in a client electronic device. In certain example embodiments, the platform 120 requires to achieve a throughput at a multi-million level, instantaneously a throughput of 800-1000 per second. A need thus exists for more efficient and reliable data storage and retrieval technologies.

Traditional Relational Database Management Systems (RDBMS's) require expensive hardware and highly skilled personnel. Moreover, a RDBMS typically prefers consistency over performance and availability. To solve these identified issues, NoSQL (Not Only SQL) database management systems (also referred to as non-relational databases or unstructured databases) emerged. A NoSQL database does not require fixed schemas or inherent relations between stored data, and also avoids join operations.

As one kind of NoSQL database, open-source Memcached may be used in an example interactive information platform. Memcached is an in-memory non-relational database designed to store a significant portion of data sets in a RAM Memory to make data access much faster than that of a traditional RDBMS. However, Memcached does not support for high availability and data persistence. Moreover, during scaling events, Memcached may lose a major portion of its data. Another open-source in-memory non-relational database, Redis, may be used in an example interactive information platform. Redis improves Memcached's functionalities by supporting write operations, persistence storage and high-availability. A person with ordinary skill in the art would understand that any other kinds of databases may be used to implement the interactive information platform.

In some example embodiments of the present invention, to satisfy high-speed reading and writing operations, data sets are stored in a memory. In the meantime, to keep data consistency, distributed data storage systems may also be used in these example embodiments. In a preferred embodiment, logs are first accumulated to a certain degree before they are merged into a memory. Moreover, data sets are preferably continually appended, disks are written sequentially. System performance therefore will not be largely affected by writing operations. A person with ordinary skill in the art would understand that data could be stored or written in any other ways.

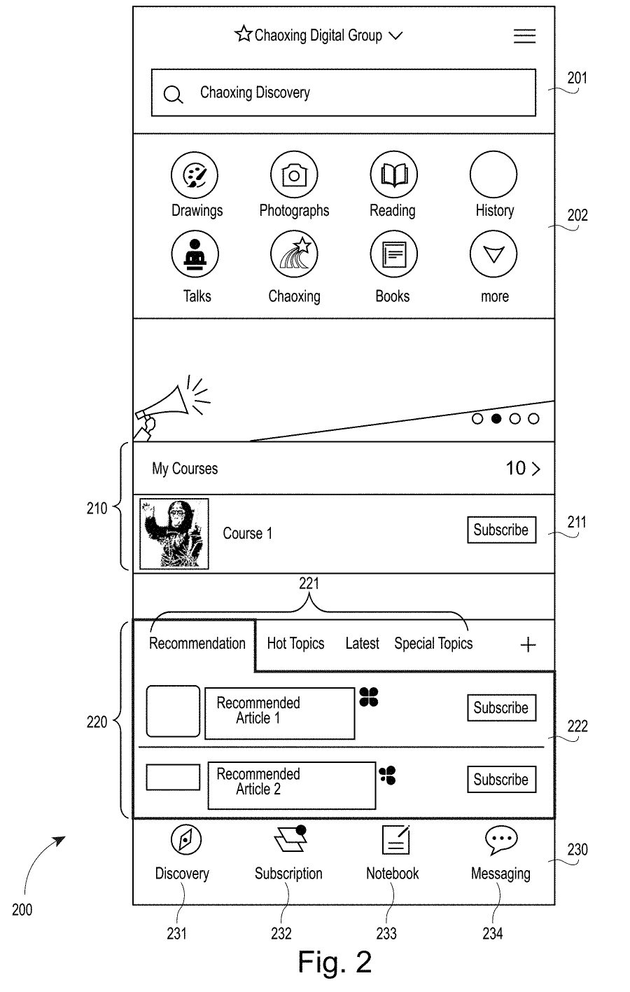

FIG. 2 shows a user interface 200 for a non-limiting example interactive information platform as displayed on the screen of a client electronic device. As can be seen in FIG. 2, this user interface, which is preferably the initial screen displayed to a client, includes a search input field 201, a customizable domain area 202, a “My Courses” area 210, a subscription area 220, and a main menu 230. The main menu 230 enables users to switch between various services provided by the interactive information platform. The main menu 230 includes menu items such as Discovery 231, Subscription 232, Notebook 233, and Messaging 234, which correspond to the customizable domain-based searching service, subscription service, notebook service and messaging service provided by the platform respectively.

The “My Courses” area 210 lists a set of courses that are available for participation. The subscription area 220 comprises a plurality of tabs 221 allowing users to view subscribed digital resources from various perspectives, for example, recommended topics, hot topics, latest topics, and special topics. Once one of the plurality of tabs (e.g., a tab 222 for displaying recommended topics) is selected by a user, its corresponding topics (e.g., the recommended topics) are displayed in the tab. Up and down arrows or scroll bars may be provided for stepping through or scrolling around these areas.

The menu item “Discovery” 231 corresponds to a customizable domain-based searching service provided by the interactive information platform. As shown in FIG. 2, the customizable domain area 202 lists various domains from which digital resources are retrieved. A domain represents digital resources filtered out in accordance with one or more criteria associated with the domain. The search input field 201 allows users to input at least one search term for retrieving digital resources from the plurality of defined domains listed in the customizable domain area 202 in accordance with the input search term(s).

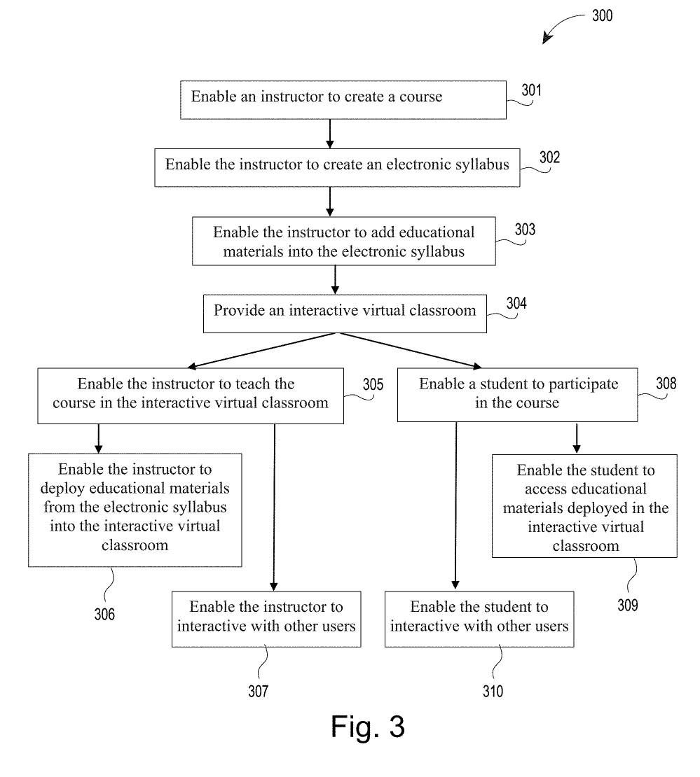

FIG. 3 shows a workflow 300 of an e-education service supported by a non-limiting example interactive information platform. The non-limiting example workflow 300 shows only an example workflow, and the e-education service may support any other alternative working scenarios.

As shown in FIG. 3, in step 301, the e-education service enables an instructor to create a course of teaching. In accordance with his/her specific desires, the instructor then develops contents for the created course, including course information, course management data, an electronic syllabus, and so on.

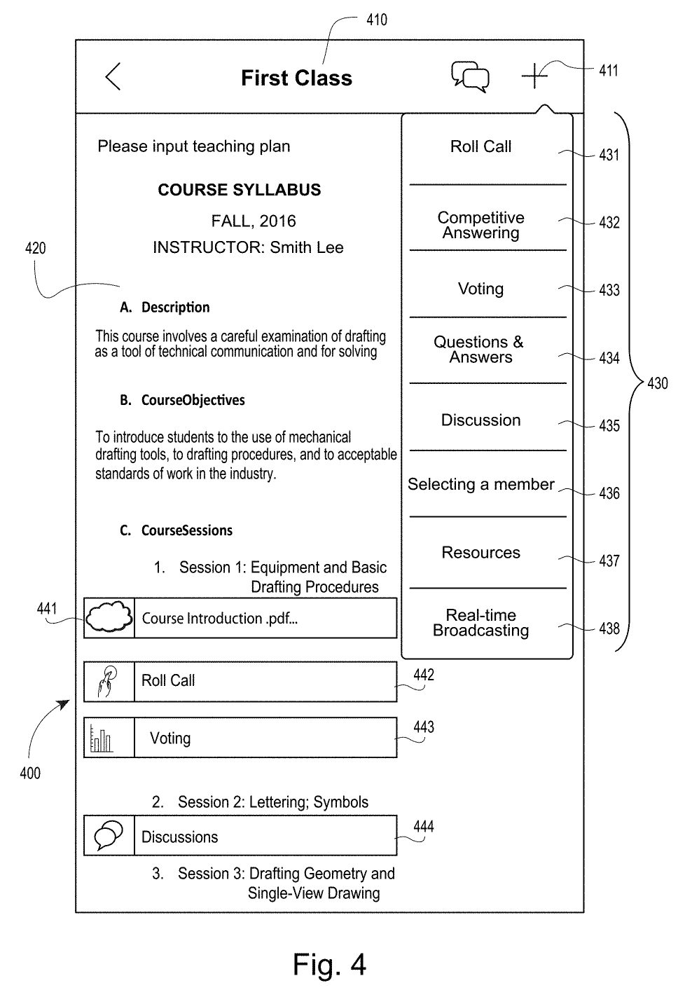

In particular, the platform may enable the instructor to create an electronic syllabus in step 302. An electronic syllabus outlines subjects and/or activities in a course of teaching. The syllabus contains various educational materials relevant to the subjects including executable software components for conducting classroom activities for the course. In step 303, the platform enables the instructor to easily add educational materials into the created electronic syllabus via a course development tool, as detailed in the disclosure in connection with FIG. 4.

In step 304, the platform provides at least one interactive virtual classroom for the course, within which the instructor can teach the course and students can participate in the course. In particular, in step 305, the platform enables the instructor to teach the course in the interactive virtual classroom, and in step 308, the platform enables another user to participate in the course as a student.

During the process of teaching the course, in step 306, the platform enables the instructor to deploy educational materials from the developed electronic syllabus into the interactive virtual classroom, in order to make certain educational materials accessible to students. On the other hand, in step 309, the platform enables the student to access educational materials deployed in the interactive virtual classroom, for example, the student may view a deployed slides show, or join a voting or a questions and answers session conducted in the classroom.

Moreover, in the meantime, the platform also enables both the instructor and student to interactive with other users in the interactive classroom in steps 307 and 310 respectively. Users in the classroom may post messages in the wall of the classroom. The messages may be visible to all users participating in the course, or only visible to selected users.

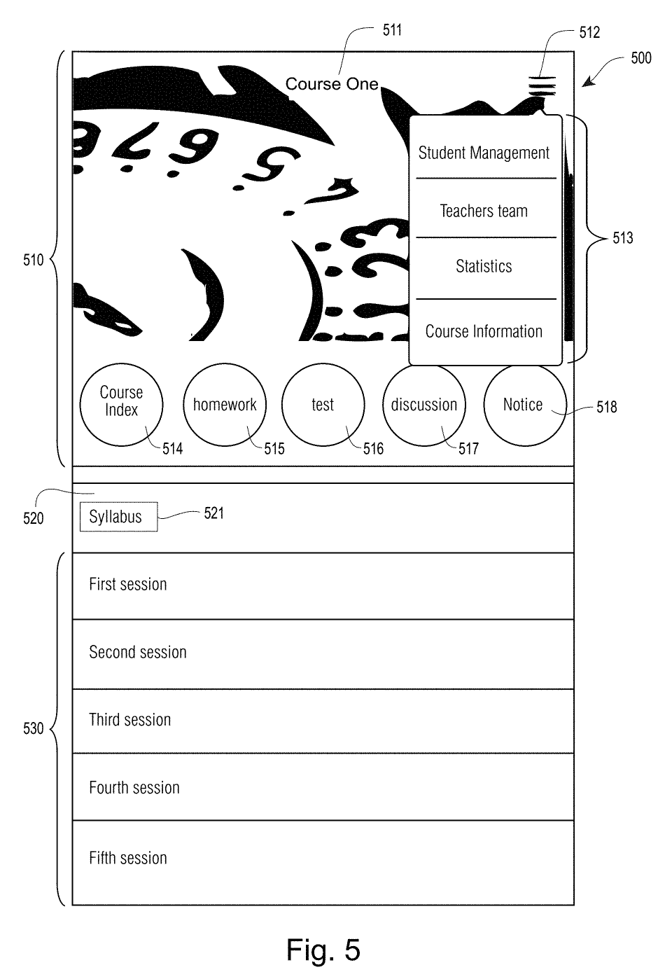

FIG. 5 shows a user interface 500 of a course provided by a non-limiting example interactive information platform. The example user interface 500 includes a display area 510 for course management, a display area 520 for accessing an electronic syllabus defined for the course, and a display area 530 listing a series of sessions of the course.

By clicking on an icon 512 on the top right corner of the display area 510, a drop-down menu 513 is popped up for the user to select from a set of menu items to perform course management tasks, like managing students or teachers, managing course information, or reviewing course statistics, etc.

The display area 510 also lists a set of selectable icons comprising a course index icon 514, a homework icon 515, a test icon 516, a discussion icon 517, and a notice icon 518. Each of these selectable icons allows the user to access the corresponding information or join the corresponding activity. For example, the user may click on the discussion icon 517 to join a class discussion, or click on the homework icon 515 to view the homework of the course.

The display area 520 includes a selectable icon 521 allowing access to an electronic syllabus of the course. Alternatively, the selectable icon 521 could also be in the form of a button or a touch sensitive area, etc. In some example embodiments, a course may have a series of syllabuses, each of which corresponds to a session or several sessions of the course. Each of these syllabuses may be accessible through a selectable icons adjacent to its corresponding session(s) on a user interface.

In some example embodiments, the electronic syllabus may be accessible to a predetermined group of users, such as the user who created the syllabus, or the instructors of the corresponding course or session(s). In other example embodiments, access rights or privileges may be specified for specific educational materials or executable software components in an electronic syllabus. Users with different roles in the corresponding course may have different access rights or privileges in connection with certain educational materials contained in the electronic syllabus. The access rights or privileges in connection with specific educational materials may vary depending on whether the educational materials have already been deployed into the corresponding virtual classroom.

A student user may also participate in a specific session of the course through clicking on any one of the sessions listed in the display area 530. After the student user click on one of the listed sessions, the student user may enter into an interactive virtual classroom provided for the specific session. In other example embodiments, an interactive virtual classroom may also be provided for the entire course or a group of sessions, and hence educational materials or user interactions in connection with multiple sessions are visible in a single virtual classroom.

FIG. 4 shows a user interface 400 of a non-limiting example course development tool for developing electronic syllabuses. An electronic syllabus outlines subjects and/or activities in a course of teaching. The syllabus contains not only static or dynamic materials relevant to the subjects of the course, but also executable software components for conducting classroom activities for the course.

The development tool is a part of an e-education service supported by an interactive information platform. It allows instructors to easily select educational materials from a wider and richer variety of materials stored on the interactive information platform. The platform stores diverse educational materials, including not only articles, books, images, multimedia data, but also executable software components. An example executable software component is an application that can be executed to conduct a class activity, such as a quiz, voting or a discussion. Educational materials can be created by the interactive information platform, or people other than the actual instructor, such as third-party teachers, animators, and so on. An instructor, via the course development tool, has access to educational materials prepared by third parties and can apply and customize these materials in developing an electronic syllabus for a course.

Referring now to FIG. 4, the user interface 400 for developing an electronic syllabus includes a display area 410 displaying the title of a course, an display area 420 displaying the detailed contents of an electronic syllabus corresponding to the course, and a drop-down menu 430 allowing a user to incorporate educational materials to the electronic syllabus. In some example embodiments, multiple instructors of a same course may be able to develop a single electronic syllabus at different times.

The display area 410 also includes a plus icon 411. When the user clicks on the plus icon 411, the drop-down menu 430 is popped up. The drop-down menu 430 includes a set of menu items, each of which allows the user to select one type of educational material into the electronic syllabus. In the example user interface 400, the drop-down menu 430 includes a “roll call” menu item 431, a “competitive answering” menu item 432, a “voting” menu item 433, a “questions and answers” menu item 434, a “discussion” menu item 435, a “selecting a member” menu item 436, a “resources” menu item 437, and a “real-time broadcasting” menu item 438. When the user selects the “resources” menu item 437, the course development tool allows the user to add various resources, e.g., graphics, audios, videos or animations, into the electronic syllabus. For example, a course introduction file 441 may be incorporated in the electronic syllabus.

Moreover, the user may also incorporate executable software components to the electronic syllabus. When the user clicks on one of the “roll call” menu item 431, “competitive answering” menu item 432, “voting” menu item 433, “questions and answers” menu item 434, “discussion” menu item 435, “selecting a member” menu item 436 and “real-time broadcasting” menu item 438, a corresponding executable software component is incorporated into the electronic syllabus. For example, as shown in FIG. 4, at a desired position of the syllabus, the user may click on the “roll call” menu item to add a “roll call” component 442 into the electronic syllabus. In addition, the user may also click on the “voting” menu item 433 to add a “voting” component 443, or click on the “discussion” menu item 435 to add a “discussion” component 444, into the electronic syllabus. During the process of teaching the course, the user may deploy the “voting” component 443 from the electronic syllabus into an interactive virtual classroom provided for the course. In this way, students in the virtual classroom may be able to join a voting activity.

In developing an electronic syllabus, various educational materials can be customized and combined in accordance with the specific needs and desires of instructors. For example, when an instructor chooses to add a “questions and answers” component into an electronic syllabus under development, the instructor may need to further define specific questions and answers for the component in accordance with her/his specific needs. Via the course development tool, instructors can easily choose and customize various educational materials provided by the platform and synthesize these materials into an electronic syllabus. In an alternative example embodiment, the platform may automatically customize certain components in accordance with existing course information. For example, the platform may be able to automatically create a “roll call” component for an electronic syllabus in association with a course, as students participating in the course are already known.

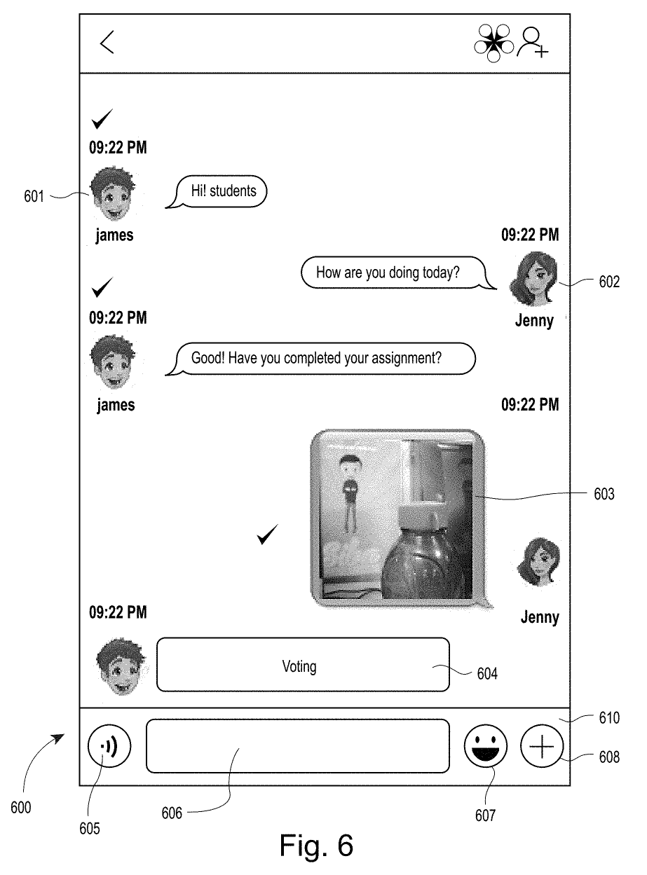

FIG. 6 shows a user interface 600 of an interactive virtual classroom provided by a non-limiting example interactive information platform for a course.

An interactive virtual classroom is provided for a course or session(s) of a course. The instructor(s) of a course may choose to enter the virtual classroom to teach the course or interact with student(s) participating in the course. After entering into the interactive virtual classroom, as shown in FIG. 6, an instructor 601 may participate in online real-time discussions with a student 602 via the virtual classroom. Textual messages or images 603 may be exchanged in the virtual classroom. The student(s) may choose to enter the virtual classroom to participate in the course and interact with the instructor(s) and other student(s) as well.

As shown in a display area 610 of the user interface 600, instructors and students can communicate with each other via different ways. The instructor 601 or student 602 may type in textual messages via an input field 606, post audio messages by clicking on a button 605 at the left bottom corner of the display area 610, or add graphics onto the wall of the classroom by clicking on an icon 607 in the display area 610. Moreover, the instructor 601 or student 602 may also incorporate digital resources from the platform onto the wall of the virtual classroom by clicking on a plus icon 608 in the display area 610.

In addition, the instructor 601 can easily pull educational materials from an electronic syllabus developed for the course into the virtual classroom to make them accessible to the student 602. In teaching the course in the virtual classroom, the instructor 601 may provide to the student 602 traditional lectures in the form of recorded video or audio, or traditional reading assignments posted on the wall of the virtual classroom. In addition, the instructor 601 may also initiate some classroom activities, such as voting, quizzes, alerts, or calling the roll, through executing software components from the electronic syllabus. As shown in the user interface 600, the instructor 601 pull the “voting” component 443 from the electronic syllabus in FIG. 4 into the wall of the virtual classroom as a “voting” component 604. The student 602 can then click on the “voting” component 604 to join the corresponding voting activity.

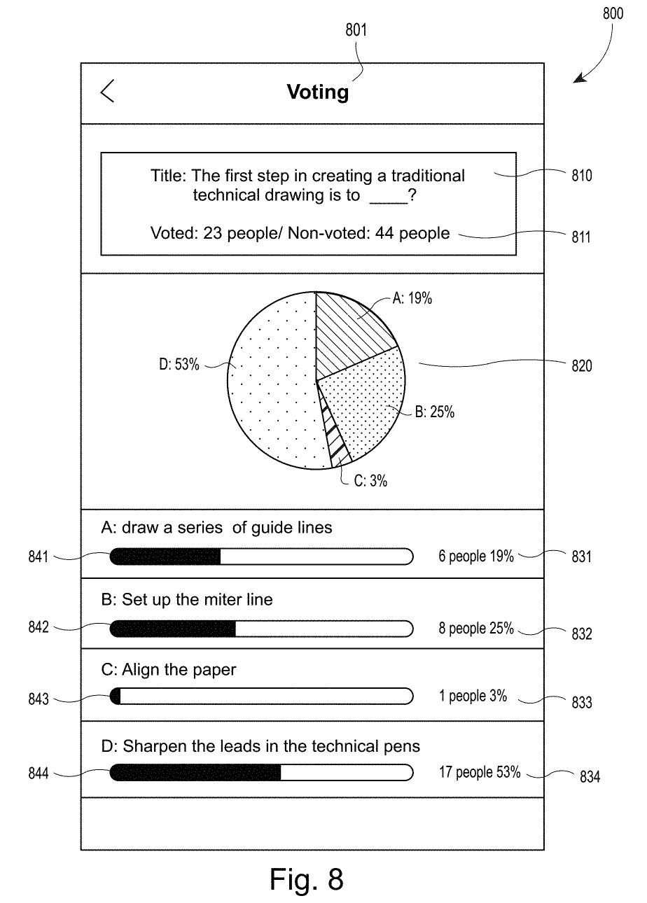

At any time, students and instructors of a course may enter its corresponding virtual classroom(s) to review course materials shared or activities conducted in the virtual classroom(s). In an example embodiment, the instructor 601 may click on the “voting” component 604 on the wall of the virtual classroom to check voting details. FIG. 8 shows a user interface 800 displaying details of a voting activity conducted in a virtual classroom provided by a non-limiting example interactive information platform.

In FIG. 8, the user interface 800 comprises a title area 801, a voting question area 810, and a summary of voting area 811. The title area 801 indicates that the user interface 800 shows details of a voting activity. The voting question area 810 displays a question of the voting activity: The first step in creating a traditional technical drawing is to ______? The summary of voting area 811 displays that 23 people have voted, while 44 people of the course have not yet voted for the listed question.

In this example embodiment, four voting choices A-D are displayed in the user interface 800. In particular, these four choices are choice A: draw a series of guide lines; choice B: set up the miter line, choice C: align the paper; and choice D: sharpen the leads in the technical pens. In an area associated with each of the voting choices, the user interface 800 specifically indicates how many people and how many percentage of people have voted for the respective voting choice, such as, in an area 831, it shows that 6 people or 6% of people have voted for the choice A; in an area 832, it shows that 8 people or 25% of people have voted for the choice B; in an area 833, it shows that one person or 3% of people have voted for the choice C; and in an area 834, it shows that 17 people or 53% of people have voted for the choice D. In addition, the user interface 800 displays a voting status bar in association with each of the voting choices. Four voting status bars 841-844 are displayed in connection with the voting choices A-D, each of these bars visually indicates the respective percentage of people who have voted for the respective voting choices.

Furthermore, the user interface 800 includes a statistical graph 820 showing proportional distribution of votes as well. The statistical graph 820 visually indicates the percentage of votes regarding each of the voting choices.

In an example embodiment, once a user clicks on one of the bars 841-844, further details of people who have voted for the corresponding voting choice will be displayed in a pop-up dialog. There are other ways of triggering the display of the users who voted for a specific choice, for example, by clicking on a corresponding portion of the statistical graph 820 in the user interface 800, or by clicking on one of the areas 831-834 in the user interface 800, and so on.

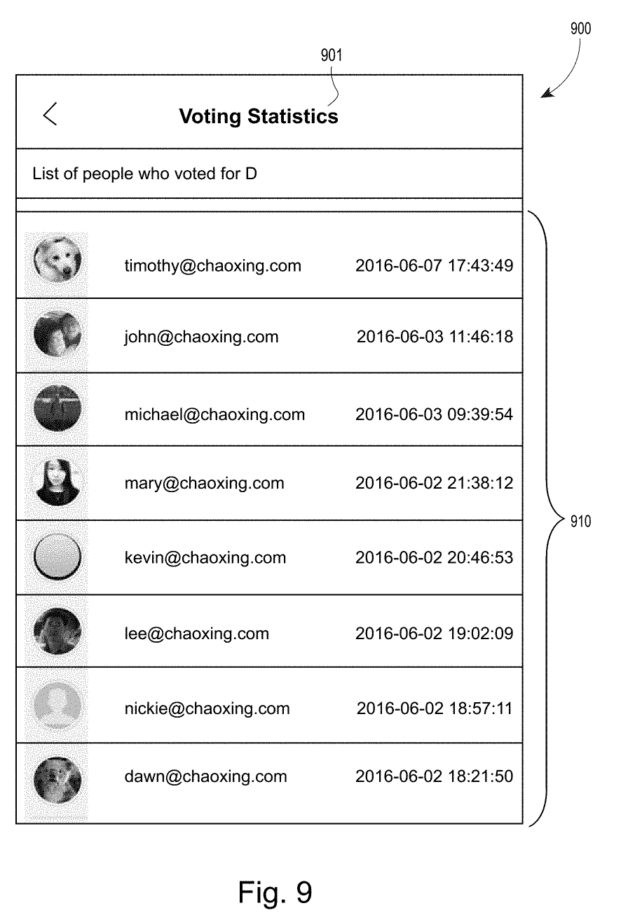

FIG. 9 shows a user interface 900 displaying details of people who have voted for a choice D in a virtual classroom of a course provided by a non-limiting example interactive information platform.

The user interface 900 comprises a title area 901 indicating the title of the dialog, and a user list area 910 listing a list of users who have voted for the choice D. Moreover, a user may be enabled to click on one of the users listed in the user list area 910 to check further detailed information about the selected user. There are other ways of displaying the detailed information of users. For example, certain user information may be displayed in the user interface 900 as a user moves his mouse or finger over a specific user shown in the user list area 910.

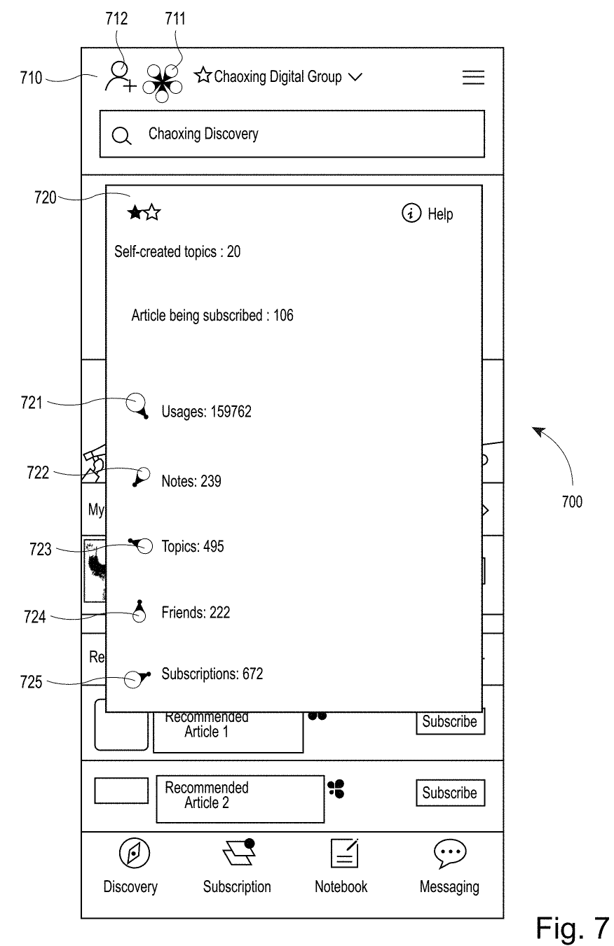

Referring now to FIG. 7, it shows a user interface 700 displaying a set of visual objects corresponding to assessment records of a user on a non-limiting example interactive information platform.

The interactive information platform may monitor and record the behaviors of a user, such as posting messages or articles, completing assignments or tests, reading articles, or participating in a class, etc. The platform may generate new statistics information whenever one of a predetermined set of events detected. The predetermined set of events include creating a post, creating a course, participating a course, answering a question, completing an assignment, and so on.

The platform generates assessment records for users or resources on it. The assessment information comprises a summary or analysis of any suitable qualitative and/or quantitative data that represents various characteristics about a user, a group of users, a course, an article, an application, etc. For example, assessment records are generated for the user based on the recorded statistics information regarding user behaviors. The assessment records include, for example, the number of messages or articles posted by the user, the number of assignments or tests completed by the user, the number of articles read by the user, or the attendance of the user.

As shown in FIG. 7, the user interface 700 includes a display area 710 indicating a specific user of the platform, and a pop-up dialog 720 displaying assessment records of the specific user. In the pop-up dialog 720, it shows that the user has created 20 topics, and 106 articles created by the user are subscribed. In addition, the dialog 720 also displays information regarding other assessment records of the user, including 159762 usages, 239 notes, 495 topics, 222 friends, and 762 subscriptions. Furthermore, the dialog 720 also shows a set of visual objects 721-725, corresponding to certain assessment records of the user: the number of usages, the number of notes, the number of topics, the number of friends, and the number of subscriptions respectively.

In an example embodiment, the size of a visual object may become larger as the value of its corresponding assessment record increases, and the color of a visual object may change as the value of its corresponding assessment record is larger than a predetermined number. In addition, as shown in the user interface 700, each of the displayed visual objects is a petal of a flower, and all of the visual objects corresponding to the assessment records of the user are combined together to be a flower 711 displayed in the display area 710 in association with a user icon 712. As a result, the current status of each user on the platform can be clearly illustrated by the combination of the visual objects in association with the user, for example, the bigger the user's flower is, the more experienced the user is.

In an alternative example embodiment, assessment records of users may be illustrated through any other kinds of forms, such as statistical graphs or tables.

In certain example embodiments, the platform the platform can analyze the historical behaviors of users to evaluate the learning performance of users. Further, the performance data provided by the interactive information platform may also be used to assist office operations, decision making and HR management.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for providing courses on an interactive information platform, comprising:
enabling a user to develop an electronic syllabus for a course, the electronic syllabus containing at least one executable software component generated based on an executable software components stored on the interactive information platform;
providing an interactive virtual classroom to allow other users on the interactive information platform to participate in the course;
enabling the user to teach the course in the provided interactive virtual classroom based on the developed electronic syllabus, wherein
during the process of teaching the course, the at least one executable software component contained in the electronic syllabus is deployed to the interactive virtual classroom to be executed.

2. The method of claim 1, wherein the software components stored on the interactive information platform is an application that is executable to perform a voting, a quiz, a roll call, or a discussion in the interactive virtual classroom.

3. The method of claim 1, wherein the at least one executable software component contained in the electronic syllabus is selected by the user from the interactive information platform.

4. The method of claim 1, further comprising enabling the user to specifically customize the at least one executable software component contained in the electronic syllabus.

5. The method of claim 1, further comprising automatically customizing the at least one executable software component in accordance with the course.

6. The method of claim 1, wherein the electronic syllabus further contains text, graphics, and/or multimedia resources.

7. The method of claim 1, further comprising enabling the user and/or any of the other users participating in the course to interactive with the at least one executable software component deployed in the interactive virtual classroom.

8. The method of claim 1, further comprising enabling the user and/or any of the other users participating in the course to post a message in the interactive virtual classroom.

9. The method of claim 1, further comprising recording behaviors of users of the interactive information platform.

10. The method of claim 9, further comprising generating a plurality of assessment records of a student user participating in the course based on the recorded behaviors of the student user.

11. The method of claim 10, further comprising displaying a plurality of visual objects on a screen, each of plurality of visual objects corresponding to one of the assessment records of the student user.

12. The method of claim 11, wherein each of the plurality of visual objects varies in response to its corresponding assessment record.

13. The method of claim 12, wherein each of the plurality of visual objects varies in size or shape in response to its corresponding assessment record.

14. A non-transitory computer readable storage medium storing a computer program having code executable by an information processing apparatus, the computer program, when executed, causing the information processing apparatus to provide execution comprising:
enabling a user to develop an electronic syllabus for a course, the electronic syllabus containing at least one executable software component generated based on an executable software component stored on an interactive information platform;
providing an interactive virtual classroom to allow other users on the interactive information platform to participate in the course;
enabling the user to teach the course in the interactive virtual classroom based on the developed electronic syllabus, wherein
during the process of teaching the course, the at least one executable software component contained in the electronic syllabus is deployed to the interactive virtual classroom.

15. The non-transitory computer readable storage medium of claim 14, wherein the at least one executable software component contained in the electronic syllabus is selected and customized by the user.

16. The non-transitory computer readable storage medium of claim 14, wherein the execution further comprises generating a plurality of assessment records of a student user participating in the course based on recorded behaviors of the student user.

17. The non-transitory computer readable storage medium of claim 14, wherein the execution further comprises enabling the user and/or any of the other users participating in the course to interactive with the at least one executable software component deployed in the interactive virtual classroom.

18. A system for providing courses on an interactive information platform, comprising:
a processing system having at least one processor, the processing system configured to:
enable a user to develop an electronic syllabus for a course, the electronic syllabus containing at least one executable software component generated based on an executable software component stored on the interactive information platform;
provide an interactive virtual classroom to allow other users on the interactive information platform to participate in the course;
enable the user to teach the course in the interactive virtual classroom based on the developed electronic syllabus, wherein
during the process of teaching the course, the at least one executable software component contained in the electronic syllabus is deployed to the interactive virtual classroom.

19. The system of claim 18, wherein the processing system is further configured to enable the user to specifically customize the at least one executable software component contained in the electronic syllabus.

20. The system of claim 18, wherein the processing system is further configured to enable the user and/or any of the other users participating in the course to interactive with the at least one executable software component deployed in the interactive virtual classroom.
